(19) United States
(12) Patent Application Publication
(10) Pub. No.: US 2005/0276229 A1
(43) Pub. Date: Dec. 15, 2005

(54) Service discovery method in a network

(76) Inventor: Mohammad Torabi, Dana Point, CA (US)

Correspondence Address: HARNESS, DICKEY & PIERCE, P.L.C., P.O. Box 8910, Reston, VA, 20195, US

(21) Appl. No.: 10/401,859

(22) Filed: Mar. 31, 2003

(51) Int. Cl. H04L 12/28

(52) U.S. Cl. 370/252; 370/338

(57) ABSTRACT

A centralized service discovery process performed in a data or telecommunications network collects a list of services available to user terminal equipment connected to a network based on user-specific data (e.g., the user's identification and preferences, the location and capabilities of the user terminal equipment). The list of services is then communicated to the user. The list of services may include home environment (HE) services the user is authorized to receive by a home network, and value-added services being offered to the user by the home network, a visited network, or third party service platforms. Both application and bearer services may further be collected in the list of available services. The service discovery process can be integrated in wireless and wireline networks, or implemented in a stand-alone service enabler.

### BACKGROUND OF THE INVENTION

The present invention relates to a method for discovering available services and more particularly to a method of discovering services available to user terminal equipment connected to a network.

### DESCRIPTION OF THE RELATED ART

Communication and data networks offer a variety of services to their users. Furthermore, services can be offered to the user by third party service provider platforms. For example, a Third Generation (3G) mobile network can provide data and communication services to the mobile terminals of subscribers. When a subscriber moves outside the coverage area of its home network, a visited network may provide such services to the subscriber's terminal under a roaming agreement.

Currently, Internet Service Providers (ISPs) randomly advertise different services to their subscribers without regard to the needs, equipment capabilities, or preferences of a particular subscriber. Vendors can separately promote their own services to potential customers by telemarketing over the telephone.

In “Value Added Services Management in 3G Networks” by N. Houssos et al., the authors propose a scheme to provide users a web-portal type interface through which a user can specify a set of keywords or categories. In response, a central database is searched, and the user is presented with a list of value added services satisfying the query.

However, there is currently no way for network operators and service providers to advertise and promote the services they can offer to a registered network user.

### SUMMARY OF THE INVENTION

The present invention provides a service discovery scheme by which a network and/or a service provider platform communicates a list of services available to a subscriber or roaming visitor. According to an exemplary embodiment, the availability of services is based on user-specific information, e.g., information obtained from user terminal equipment that registers with a network.

The types of services in the communicated list may include home environment (HE) services, which the home network authorizes the user to receive, for example, as part of the subscription agreement. The list may also include value-added services offered by the home network, or a visited network currently serving the user (i.e., while the user is roaming). The user may also be notified of value-added services available from third party service platforms or other supporting networks not currently serving the user.

However, the user of a visited network may not necessarily have a service subscription with a particular home network. For example, the user terminal equipment may be activated and registered through a pre-paid card, debit or credit card account.

According to an exemplary embodiment, the service discovery scheme of the present invention may allow a roaming user to receive information on the availability of their HE services at a visited network currently serving the network. For example, the serving visited network may first determine a list of HE services normally offered to the user by its home network. However, the visited network may not be able to offer all of the determined services because of a roaming agreement with the home network or the limited capabilities of the visited network. Thus, the serving visited network may provide a list of virtual home environment (VHE) services to the user, i.e., the subset of those HE services that the visiting network is able to provide.

According to an exemplary embodiment, a service discovery feature may be activated in response to the registration of a roaming user in a serving network in order to provide a list of services that can be offered to the registered user through the network. For instance, the serving network can be either the user's home network or the visited network. The services may be offered by the serving network either directly through its own service platform(s), via a third party service platforms, or by a supporting networks.

According to an exemplary embodiment, the service discovery function can be initiated upon the user's request, or serving network's initiation. This function can be performed at either the serving network or at a stand-alone server residing in a third party service platform.

Other advantages and embodiments of the present invention will become more apparent from the detailed description given hereinafter. However, it should be understood that the detailed description and specific examples, while indicating exemplary embodiments of the present invention are given by way of illustration only. Various changes and modifications within the spirit and scope of the invention will become more apparent to those ordinarily skilled in the art from this detailed description.

### BRIEF DESCRIPTION OF THE DRAWINGS

The present invention will become more fully understood from the detailed description given below and the accompanying drawings, which are given for purposes of illustration only, and thus do not limit the present invention. In the drawings, like reference numbers and symbols refer to like features.

FIG. 1A is a sequence diagram illustrating a service discovery function implemented at a serving network, which is initiated by user terminal equipment according to an exemplary embodiment of the present invention.

FIG. 1B is a sequence diagram illustrating a service discovery function implemented at a stand-alone entity, which is initiated by user terminal equipment according to an exemplary embodiment of the present invention.

FIG. 2A is a sequence diagram illustrating a service discovery function implemented at a serving network, which is initiated by the serving network according to an exemplary embodiment of the present invention.

FIG. 2B is a sequence diagram illustrating a service discovery function implemented at a stand-alone entity, which is initiated by the serving network according to an exemplary embodiment of the present invention.

FIG. 3 is a sequence diagram illustrating a centralized service discovery function implemented in a 3G mobile network according to an exemplary embodiment of the present invention.

### DETAILED DESCRIPTION OF EXEMPLARY EMBODIMENTS

The present invention relates to a service discovery scheme that enables users of a network to receive information on the availability of services. The present invention can be used to allow a user terminal equipment to locate, interrogate and invoke the enabler of one or more of the available services. Throughout this specification document, the terms “user” and “user terminal equipment” are used interchangeably.

The term “network” is used to refer to any telecommunication system of two or more nodes supporting, for example, the exchange of voice, data, images, video (either in single or multimedia format). Such networks may include any of fixed, wireless, and mobile networks; service provider platform networks, Internet Protocol (IP) networks; second generation (2G) and third generation (3G) networks, and beyond.

The home environment (HE) services are those provided by the home network. According to exemplary embodiments, the discovery scheme may provide the user with a list of available HE services and value-added services. Exemplary embodiments of the present invention can also be applied to services falling in the categories of “application services” and “bearer services.”

HE services include any services that a network user is authorized to receive by a “home network.” Home networks can include, but are not limited to, telephone service providers, Internet service providers, 2G and 3G networks, and other types of fixed or wireless communication systems.

In one exemplary embodiment, a user terminal equipment may receive HE services based on his subscription plan or agreement with a home network service provider. However, HE services are not limited to services authorized according to a subscription. For example, the home network may be a network operator (e.g., a long distance phone company) that issues a card (e.g., calling card) entitling the user to services. In such instances, the services accessed by the customer using the card can be referred to as HE services. The above examples of home networks and HE services are provided for purposes of illustration, and are not meant to be an exhaustive list.

In another exemplary embodiment, a user terminal equipment may receive HE services without a long-term contractual subscription, e.g., based on a “per-paid card”, “real-time debit card paid” or “post-paid credit card” arrangement. In such a case, the home environment may correspond to the serving network that activates, registers, and serves the user terminal equipment.

When a user roams, and is registered in a visited network, the visited network may have a roaming agreement with the user's home network to provide some of the same HE services authorized for the user by the home network. These types of services offered by the visited network are referred to as virtual home environment (VHE) services. While visited networks may include wireless networks into which a mobile user roams, they are not limited to such networks.

For example, when a user travels to a geographic region not serviced by his normal telephone company or Internet service provider (ISP), the telephone company or ISP serving the region may provide, pursuant to a roaming agreement with the home network, many of the same HE services the user enjoys when at home.

It should be noted that the types of VHE services available through a visited network may not only be limited by its agreement with the user's home network, but also by the available resources and capabilities of the visited network.

Value-added services (VAS) include those services that are available, but not currently authorized for a network user. Value-added services can be offered to the user by either the home network, a visited network into which the user roams, or a third party service provider. For example, value-added services may include services that are not currently part of a user's subscription agreement, but are offered by the home network for an additional fee or charge.

Application services are services that support either functionality or the content available to a network user. Types of application services include, but are not limited to, caller-ID and call waiting in telephone and mobile networks, video-streaming and games on the Internet, availability of certain channels on cable and air television networks, etc.

Bearer services include those services supporting either the connectivity or the data transmission for a network user. In this sense, data transmissions covers the communication or transmission of all types of data including, but not limited to, voice, image, digital, video, or combinations thereof, etc. These services generally affect the sessions that one endpoint user terminal equipment (e.g., mobile phone, laptop, etc.) establishes with another endpoint user terminal equipment.

Bearer services are usually defined in terms of services and facilities necessary to provide minimum standards of interconnectivity, e.g., a minimum bandwidth or quality of service. Examples of bearer services include, but are not limited to, public switched telephone networks (PSTN), integrated services digital networks (ISDN), packet-switched data networks, digital subscriber line (DSL), and internet protocol (IP) networks.

According to an exemplary embodiment of the present invention, a centralized service discovery function is activated in response to a user terminal equipment being registered in a serving network using either an existing subscription, pre-paid card, real-time debit card, post-paid credit card, etc. Once the user is registered with the serving network, either the user or the serving network may initiate the service discovery feature.

In an exemplary embodiment, the service discovery function can be implemented in a data processing system using programming techniques and hardware that will be readily obvious to those ordinarily skilled in the art. For example, the service discovery function can be implemented and performed in a server or other processing system located in the user's home network. In alternative exemplary embodiments, the service discovery function may be executed either in a processing system in a visited network that is currently serving a roaming user, or in a stand-alone entity, e.g., a server located at a third party service platform.

It should be noted that the term “roaming” should not be construed as being limited to mobile or wireless terminal users who enter the coverage area of a visited wireless network. The term also refers to any user who registers with, or connects to, any network (wireless or wireline) that is different than the user's home network.

Once activated, the service discovery function provides a list of services that the serving network can offer to the registered user. The serving network could be either the user's home network or a visited network. According to an exemplary embodiment, when a user connects to, or roams in the coverage area of, a visited network, the visited network registers the user and acts as the serving network.

However, alternative exemplary embodiments cover situations where the user may be required to connect to a visited network that does not act as the serving network. In such situations, the visited network serves as a “proxy” of the home network (or other serving network). Accordingly, the user will be registered with, and receive services from, the serving network; the proxy acts as a connection and point of access for relaying data and services between the user terminal equipment and the serving network.

The serving network may offer the user services directly through its own service platform(s), via one or more third party service platforms, and through one or more supporting networks. According to an exemplary embodiment, all services that are offered to the user have already been registered with the serving network before they can be presented to the user by the service discovery function. According to an exemplary embodiment, the serving network initiates the service discovery function in response to the user registering with the network. In an alternative exemplary embodiment,, the serving network may activate the service discovery function only after receiving a service discovery request message from the user terminal equipment.

In an exemplary embodiment, the serving network may trigger the service discovery function when the user registers with the serving network. Such triggering does not require the user's prior knowledge or action.

According to an exemplary embodiment, the user terminal equipment may be configured to automatically send a request for service discovery to the serving network after being registered. Alternatively, the user terminal equipment may include an input device (e.g., pushbutton on a keypad) and/or user interface through which the user can elect to send the service discovery request. For instance, the user may be prompted to respond to a question or offer for service discovery, e.g., “Would you like to view the list of services we offer?”

In another exemplary embodiment, the user's preference to automatically activate service discovery can be programmed in the user's profile stored in the home network. Those of ordinary skill in the art will readily contemplate the different methods by which service discovery will be requested or initiated by either the user or the serving network.

In another exemplary embodiment, the list of available services collected by the service discovery function may be communicated to the user in any number of ways. For example, the list of services may be identified to the user via a display device and/or a speaker device outputting a voice signal in the user terminal equipment.

In an embodiment where the user's home network acts as the serving network, the home network may choose to offer services in addition to the HE services the user is already authorized to receive (i.e., offer value-added services to the user). The service discovery function may collect information on such value-added services to be communicated to the user. Also, information regarding third-party services and services offered by supporting networks may be collected by the home network. Thus, when the user's home network is the serving network, the list of available services collected and sent to the user may include:
1. application services in the list of HE services authorized for the user (it should be noted that in an alternative embodiment where the serving network is a visited network, not all HE services may be offered to the user),
2. additional value-added application services that are not included in list of HE services but available through other service enablers, which the serving network may wish to offer, and/or
3. bearer services in addition to what the user receives in its home network.

Another exemplary embodiment of the present invention is directed to the execution of a service discovery function after a user registers into a visited serving network. Accordingly, the visited network may prepare and transmit to the user a list of available services. However, since the visited serving network may be limited by, e.g., its own capability and resources, the capabilities of supporting networks, the user terminal equipment and the terms of the roaming agreement, the serving visited network may not include all the HE services the roaming user is authorized to receive in the list of available services.

Accordingly, in an exemplary embodiment, a serving visited network may transmit to the user a service portfolio that includes the following types of services:
1. HE application services that the visited serving network can offer as VHE services (based on the visited network's capabilities, the roaming agreement, etc.),
2. Additional value-added application services that and the visited network may wish to offer on its own and independent of the home network, and/or.
3. Bearer services, including those comparable to what user receives in the home network and any additional bearer services offered by the visited network.

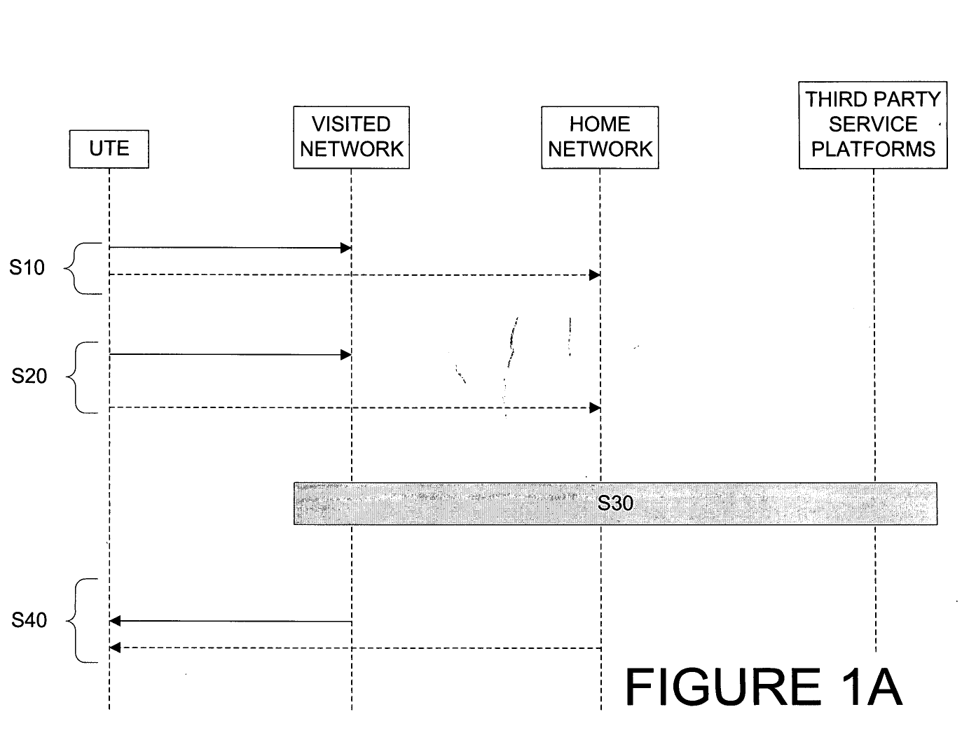

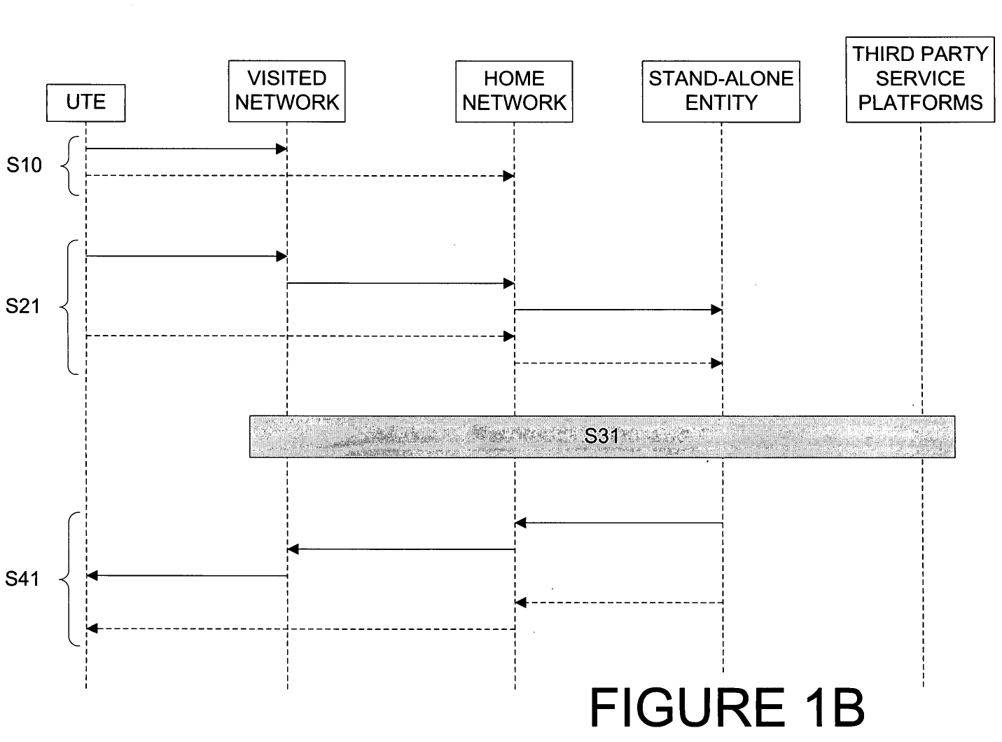

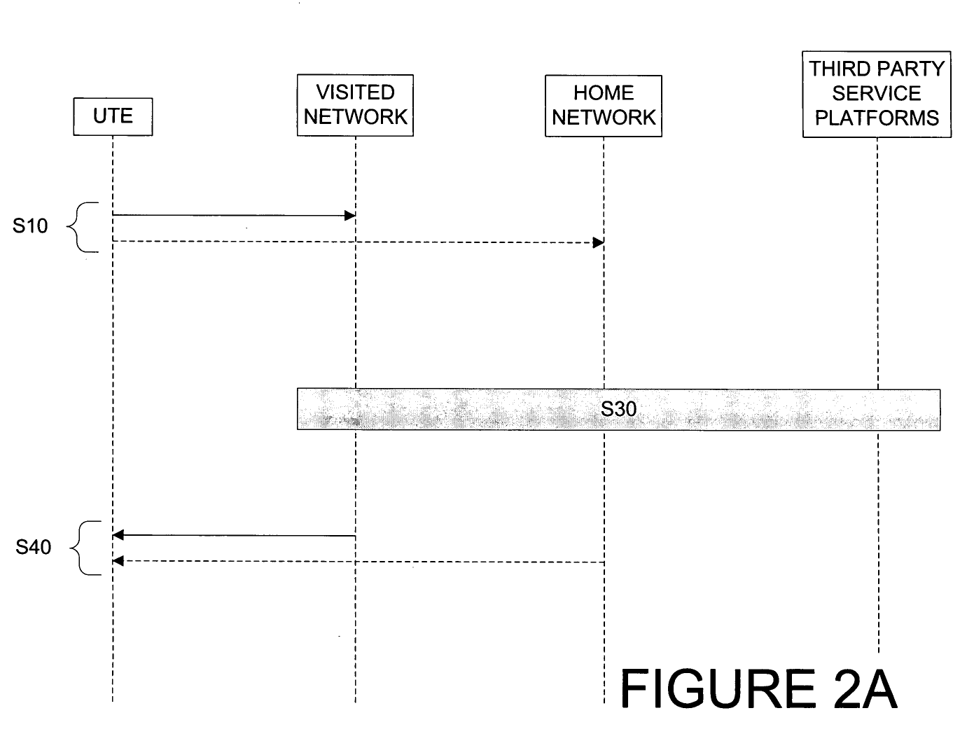

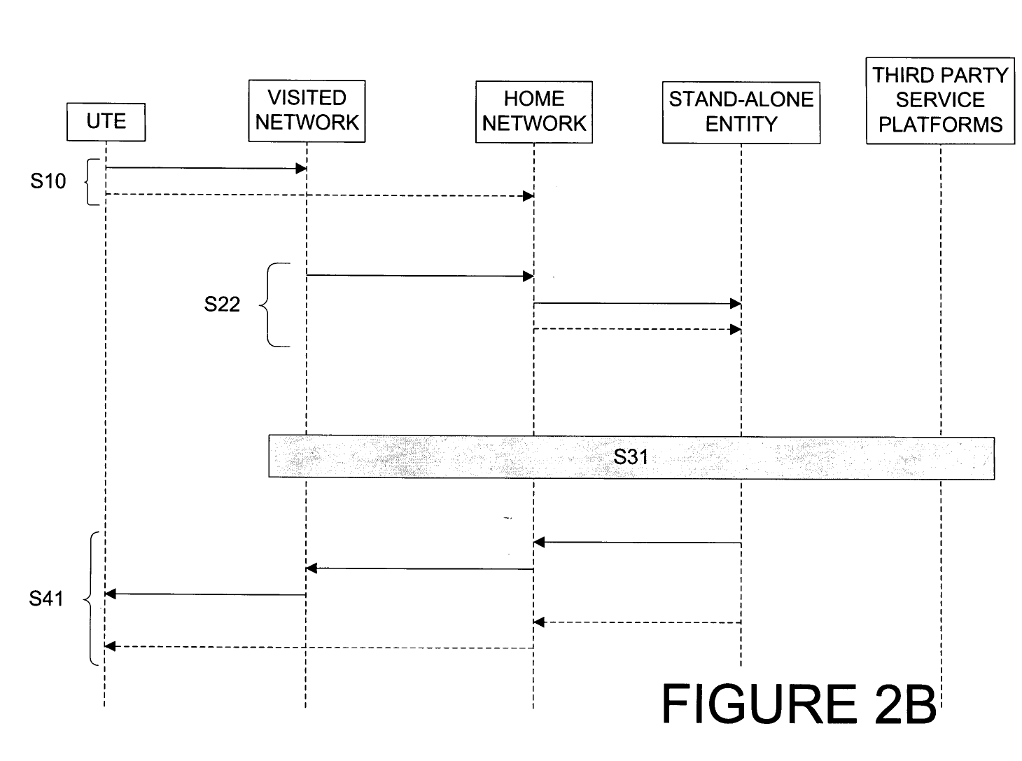

FIGS. 1A, 1B, 2A, and 2B are sequence diagrams each illustrating the steps involved in initiating and executing the service discovery function according to exemplary embodiments of the present invention. Each of these figures illustrate both exemplary embodiments where the serving network is either a visited network in which the user has roamed, or a user's home network.

It should be noted that these figures are provided for the purpose of illustrating exemplary embodiments and should in no way be construed to limit the present invention. For example, in instances where the figures show a registration message being sent to a serving visited network, it should be noted that other registration messages may also be sent to register the user with other entities (e.g., the home network).

In each of the aforementioned figures, the steps illustrated by solid arrows indicate messages that are transmitted between the various entities if the serving network is a visited network. On the other hand, the steps illustrated by dotted arrows indicate messages that are transmitted if the serving network is the home network.

As discussed above, when the user roams, the home network may be the serving network while the visited network acts as a proxy. This may be the case when, based on technical limitations or a business agreement, the visited network relinquishes its control over the handling of service to the home network. For the purposes of the description below, the instances where the user either connects directly to the serving home network, or connects indirectly to the serving home network via a visited network in the case of roaming, will be illustrated the same by the figures. For example, in FIG. 1A, the dotted arrow in step S10 shows a registration message transmitted either directly to the home network or indirectly to the home network via a visited network acting as a proxy.

FIG. 1A is a sequence diagram illustrating a service discovery function implemented at a serving network (either a home or visited network), which is initiated by user terminal equipment according to an exemplary embodiment of the present invention.

Referring to FIG. 1A, step S10 is the transmission of a registration message from the user terminal equipment to the serving network (either the visited or home network). According to an exemplary embodiment, the registration message may include user-specific information, which is extracted by the serving network. For example, the types of user-specific information extracted from the registration message may include, but are not limited to, user identification information (e.g., identifying the user himself or the user terminal equipment) and information regarding the location (e.g., specific geographical location or general region) of the user terminal equipment. The user terminal equipment location information may also identify a proxy network from which the user is sending the information.

The serving network may obtain further user-specific information useful for service discovery from information extracted from the registration message. For example, the registration message may include identification information regarding the user terminal equipment, e.g., a mobile identification number (MIN). From such information, the serving network may determine the type and capabilities of the user terminal equipment being used to connect to the network. Also, user identification information may be used by a network (e.g., home network) to perform a lookup of user profiles to determine certain preferences of the user. Information regarding the user preferences and capabilities of the user terminal equipment may help determine the types of applications or bearer services that should be offered to the user.

In step S20, a service discovery request is sent from the user terminal equipment to the serving network. In an exemplary embodiment, as discussed above, the user can initiate the service discovery function (e.g., by pushing a pushbutton or speaking a voice command), thus causing the service discovery function to be sent. In an alternative exemplary embodiment, the user terminal equipment may be configured to automatically send the service discovery request. In another exemplary embodiment, the serving network may send a service discovery message to the user terminal equipment (not shown) to determine whether the user wants to discover the available services. In response to the service discovery message, the user terminal equipment may prompt the user to indicate whether he/she wants to see what services are available. If the user responds affirmatively, the user terminal equipment may then transmit the service discovery request of step S20.

In step S30, the service discovery function is executed by the serving network. In an exemplary embodiment, the service discovery function is a program or subroutine executed by a data processing system in the serving network for collecting the list of HE services, additional bearer services and value-added services available to the user. The services may include application services and bearer services by the visited network. The services may also include value-added services offered by service platforms other than the serving network, e.g., third party platforms.

Furthermore, in an exemplary embodiment where the serving network is a data network, the service discovery function or portions thereof can be executed using any data processing systems and databases located at the application server(s), common service enabler(s), specific service enabler, service registry, common directory or other component(s) of the data network's service layer architecture.

In an exemplary embodiment where the serving network is a 3^{rd} generation (3G) network, the service discovery function or portions thereof can be executed using any data processing systems and databases located at the application server (AS), home subscription server (HSS), authentication, authorization & accounting (AAA), call session control function (CSCF), open service access service capability server (OSA SCS) or other component(s) and subsystem(s) of the 3G network.

In an exemplary embodiment where the visited network is serving the user, the service discovery function may include comparing the list of the user's HE services with the list of services that the serving visited network and the user's home network have agreed upon to offer roaming users (via a roaming agreement). Such comparison can result in a list of VHE services offered to the user.

In an exemplary embodiment, the service discovery function may also determine which of the HE services the serving visited network can support, e.g., based on the available of resources and the capabilities of the visited network, in order to determine which HE services to include in the list of available VHE services.

In addition, the serving visited network may include other local services, which are not included in the list of VHE services, as value-added services.

According to an exemplary embodiment, the user identification information and user location information is used to determine at least some of the available services. For example, when a home network is serving the user, the service discovery function may use the user identification to perform a lookup of a subscriber database maintained by the home network service provider. The subscriber database may include a user profile for each subscriber identifying the HE services authorized for each user, example of a corporate subscription with multiple users. Based on the subscriber database lookup, the home network can collect the list of HE services available to the user.

The user profiles stored in the subscriber database may further include user preferences and/or user terminal equipment capabilities. Such information may be used to determine the types of value-added services to offer the user. For example, the user profile may include a minimum data rate the user prefers to maintain, or a maximum data rate the user terminal equipment is able to maintain. This data may be used to determine, e.g., the types of bearer services to offer the user.

Also, the user profile may include the user's preferences or user terminal equipment capabilities for determining the types of application services to offer the user. For instance, the user profile may indicate a user preference to receive notification of new streaming video services, games, etc. that are available. The profile may also include information regarding the operating system or other hardware/software capabilities of the user terminal equipment. Accordingly, only application services supported by the user terminal equipment may be included in the list of discovered services.

Referring to FIG. 1A, the step S30 is shown as spanning across the home network, visited network, and third party service platforms. This illustrates that although the service discovery function is executed at a central location (the serving network or a service discovery enabler interconnected to the serving network), service discovery may involve interaction with other networks and/or service platforms. An example of such interaction is the interrogation or querying by the serving network of these entities.

For instance, a service discovery function executed at serving visited network may perform a database lookup to determine the user's home network and an accompanying roaming agreement. A query may be sent to the home network to obtain the user's HE services. Accordingly, the home network would respond to the query by performing a lookup of the subscriber database and retrieving for the visited network a list of HE services (or at least the user's HE services that are included in the roaming agreement). The query may also be used to retrieve user preferences and/or user terminal equipment capabilities from the home network.

In addition, the serving network may perform a query of third party service platforms and other supporting networks to determine services they offer. Such queries may be performed before receiving the service discovery request from the user, such that the services offered by these networks and service platforms are registered in a service database (e.g., in an application server or service discovery enabler) of the serving network. According to an exemplary embodiment, these registered services can be included in the list of available services as value-added services.

In another exemplary embodiment, the service discovery function may perform a lookup of the service database using information regarding the capabilities and/or location of the user terminal equipment to determine which of the registered services can be offered to the user as value-added services.

For example, the registered services offered by some third party platforms may be limited to specific regions and/or require certain capabilities in the user terminal equipment.

According to another exemplary embodiment, the service discovery function may, upon execution, perform a database lookup using the user terminal equipment capabilities and/or user location information to determine one or more third party service platforms. The service discovery function may then collect information regarding available services by querying these determined third party service platforms. In response, the third party service platforms may identify services to be included in the list of value-added services.

For example, one third party service platform may have an exclusive right (e.g., contractual agreement with local networks) in a particular geographical region to offer certain types of services. Thus, the serving network may perform a lookup of the service database to determine third party service platforms corresponding to the location of the user terminal equipment.

The output of the executed service discovery function is a list of available services. Step S40 involves the communication of this list in a service discovery response message from the serving network to the user terminal equipment. The user terminal equipment may thus output the list to the user. According to an exemplary embodiment, the list may distinguish between HE services authorized for the user and value-added services being offered to the user. The list may also distinguish between bearer services and application services.

After the list is received at the user terminal equipment, the user terminal equipment may locate, interrogate, and invoke the various service providers to provide one or more of the listed services. The user terminal equipment may perform these functions automatically, or under the direction of the user.

For example, the user terminal equipment may either be displayed to the user (e.g., via text, images or video clips), or output to the user via voice/audio signal by the user terminal equipment. According to an exemplary embodiment, the user terminal equipment may include a user interface allowing the user to choose any of the listed services, using techniques well known in the art (e.g., pushbutton, spoken command, screen-touch, etc.). The user's choice may be sent to the serving network as a service registration request to the serving network. In another exemplary embodiment, the user terminal equipment may be programmed or configured to automatically choose and send a service registration request for certain listed services.

FIG. 1B is a sequence diagram illustrating a service discovery function implemented at a stand-alone entity, which is initiated by user terminal equipment according to an exemplary embodiment of the present invention. The centralized service discovery process illustrated in FIG. 1B is similar to that described above with respect to FIG. 1A. Thus, like reference numbers in these figures illustrate like steps, and a description of these steps will not be repeated.

A difference between the exemplary embodiment of FIG. 1B and that of FIG. 1A is that the service discovery request is ultimately transmitted to a stand-alone entity, a service discovery enabler, which is not part of the serving network. Thus, step S21 illustrates the service discovery request being transmitted from the user terminal equipment to the stand-alone service discovery enabler via the serving network. In FIG. 1B, step S21 illustrates that the service discovery request is transmitted from a serving visited network to the stand-alone entity via the home network. However, it should be noted that the request may be transmitted directly from the visited network to the standalone entity according to another exemplary embodiment.

Similar to the embodiment shown in FIG. 1A, the service discovery request of step S21 may be sent by the user terminal equipment in response to a service discovery message (not shown) sent to the user terminal equipment. This service discovery message may be a message sent by the stand-alone service discovery enabler to determine whether or not the user wants to discover available services.

The service discovery function is thus executed at the stand-alone service discovery enabler according to step S31, as shown in FIG. 1B. The executed service discovery function collects the list of available services in a similar fashion as described above with respect to step S30 in FIG. 1A, a description of which will not be repeated. In exemplary embodiments, the stand-alone entity may query the home network's databases regarding the user's HE services, preferences, and terminal equipment capabilities. In an alternative exemplary embodiment, the stand-alone service discovery enabler may include its own database containing such information.

According to step S41, the stand-alone entity communicates the resultant list of available services in a service discovery response to the user terminal equipment. Similar to step S21, when the serving network is a visited network, the service discovery response may be transmitted to the visited network via the home network, or may be directly transmitted to the visited network.

While FIGS. 1A and 1B illustrate user-initiated service discovery, service discovery may also be initiated by the serving network in response to registration of the user according to exemplary embodiments illustrated in FIGS. 2A and 2B.

The service discovery process illustrated in FIGS. 2A and 2B include the steps of registering the user in the serving network (S10) and sending the list of available services collected by the service discovery function (S40). The performance of these steps are similar to the corresponding steps described above with respect to FIGS. 1A and 1B, and will, therefore, not be described again.

FIG. 2A is a sequence diagram illustrating a service discovery function implemented at a serving network, which is initiated by the serving network according to an exemplary embodiment of the present invention. Since the serving network initiates the service discovery function in response to the user being registered (step S10), no service discovery request message is transmitted. Thus, FIG. 2A shows the service discovery function being activated in step (S30). The performance of the discovery function is similar as described above with respect to FIG. 1A; thus, a detailed description will not be repeated. The list output from the service discovery function is transmitted to the user terminal equipment in step S40.

FIG. 2B is a sequence diagram illustrating a service discovery function implemented at a stand-alone entity, which is initiated by the serving network according to an exemplary embodiment of the present invention.

In the exemplary embodiment of FIG. 2B, the stand-alone entity (i.e., service discovery enabler) is not part of the serving network. Thus, in response to the registration of the user in the serving network (step S10), the serving network (which is either the home or visited network) sends a service discovery request message to the stand-alone service discovery enabler in step S22.

Steps S31 and S41 are performed similarly to the corresponding steps in FIG. 1B to collect the list of available services and communicate the list to the user terminal equipment. Thus, a detailed description of these steps will not be repeated.

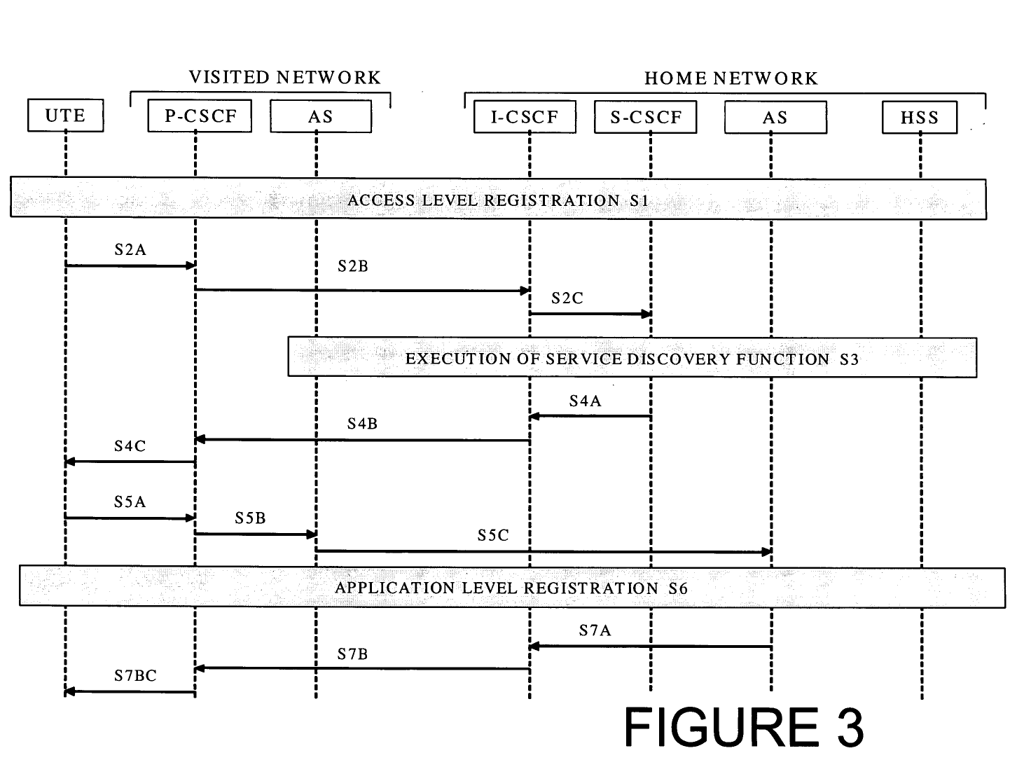

According to an exemplary embodiment, a centralized service discovery process may be implemented in a 3G mobile communications network. FIG. 3 is a sequence diagram using architectural elements of a 3G mobile network to further illustrate an exemplary embodiment illustrated FIG. 1A.

Specifically, FIG. 3 illustrates an exemplary embodiment where a roaming user terminal equipment UTE connects to the serving home network via a proxy (visited network). The user terminal equipment initiates the service discovery function, which is executed by a data processing system in the home network.

As illustrated in FIG. 3, the visited 3G network includes a proxy call state control function P-CSCF and an application server AS. The home 3G network includes an interrogating call state control function I-CSCF and a serving call state control function S-CSCF, an application server AS, and a home subscriber server HSS. The implementation and configuration of the aforementioned systems and servers in the visited and home network will be readily apparent to those of ordinary skill in the art.

In FIG. 3, step S1 illustrates the execution of a registration subroutine to perform user registration according to step S10 in FIG. 1A.

Steps 2A, 2B, and 2C corresponds to step S20 in FIG. 1A, illustrating the transmission of the service discovery request from the user terminal equipment UTE to the serving home network via the visited network. The service discovery request may be received by the serving call state control function entity S-CSCF of the home network.

The service discovery function (step S30 in FIG. 1A) is executed by a service discovery subroutine/enabler illustrated by step S3 in FIG. 3. The execution of this subroutine, which basically enables the retrieval, comparison and listing of services, may be assigned to the serving call state control function entity S-CSCF, or to an Application Server AS either in the serving network or in a stand-alone third party platform. As described above with respect to FIG. 1A, execution of the service discovery function may involve entities in the visited and home networks, as well as third party service platforms (not shown in FIG. 3).

Steps S4A, S4B, and S4C shows the transmission of a service discovery response message for communicating the list of available services to the user terminal equipment UTE. Thus, these steps correspond to step S40 in FIG. 1A.

FIG. 3 further illustrates steps S5A-S7C that may occur in response to the service discovery process being completed. These steps are provided to illustrate the sequence in which the service discovery procedure may occur according to exemplary embodiment, i.e., after registration of the user terminal equipment (access level registration) and before the user actually chooses to be registered for specific services (application level registration).

In FIG. 3, steps 5A, 5B, and 5C illustrate transmission of a service registration request from the roaming user, which acknowledges receipt of the list and requesting, e.g., application level registration for a particular application service of interest. In step S6, an application level registration sub-routine can be executed by the application server AS of the home network.

Steps 7A, 7B, and 7C in FIG. 3 is a response notifying the roaming user terminal equipment UTE of the completion of application level registration for the requested services.

FIG. 3 illustrates an exemplary embodiment where the service discovery function (step S3) is executed in the S-CSCF entity in a 3G mobile user's home network. However, FIG. 3 is merely provided for the purposes of illustration, and in no way limits the present invention. In an exemplary embodiment where the home network acts as serving network, the service discovery function may be executed by any combination of hardware and software in the home network. Furthermore, the service discovery operations could be performed by a system (e.g., a S-CSCF entity) in a serving visited network, by a service enabler such as an application server AS, or by a stand-alone system not located within the home or visited networks.

In another exemplary embodiment, the service discovery function, or portions thereof, may be executed within the user terminal equipment itself. In such an embodiment, the user terminal equipment may contain any combination of hardware and software, as will be contemplated by those skilled in the art, to perform any combination of the operations described above in connection with the service discovery function. The user terminal equipment may, for example, initiate the service discovery function after registering with the serving network or after being prompted by the user via any input device. The user terminal equipment may then output the list of available services to the user as the service discovery function is being performed or after the function has been executed.

While FIG. 3 illustrates an exemplary embodiment implemented a 3G mobile network, it should be noted that a centralized service discovery process according to exemplary embodiments could be implemented as a service enabler in any other telecommunications or data networks, including wireless and wireline networks, as will be readily apparent to those of ordinary skill in the art.

It should be noted that the types of services collected by the service discovery process of exemplary embodiments of the present invention are not limited to those described above and may include any type of services as will be contemplated by those ordinarily skilled in the art. Such services may include, e.g., push services (data delivery initiated by a server rather than the user terminal equipment), location based services (LCS), etc.

Furthermore, although exemplary embodiments of the present invention have been described above with respect to one home network, it should be noted that a user may be authorized to receive HE services from more than one network. For example, the user may have subscription agreements with multiple service providers. Thus, in an exemplary embodiment, the HE services collected during the service discovery process may include services from multiple network service providers. Other such variations are covered by the present invention as will be obvious to those of ordinary skill.

In the above-described exemplary embodiments, the service discovery function is initiated in response to the user registering with the serving network. However, the present invention is not thus limited. In an alternative exemplary embodiment, the service discovery function may be executed periodically to collect a list of available services for a user, or group of users, not currently registered with the serving network. In such an exemplary embodiment, the serving network (or stand-alone system) may communicate the list to the user once the user registers with the serving network.

Exemplary embodiments of the present invention being thus described, it will be obvious that these embodiments may be varied in many ways. Such variations are not to be regarded as a departure from the spirit and scope of the invention. All such modifications as would be readily apparent to those skilled in the art are intended to be included within the scope of the following claims.

1. A method of performing discovery of services available to a network user, comprising:
communicating a list of one or more available network services to the network user based on user-specific information.

2. The method of claim 1, wherein the communicating step communicates at least one home environment (HE) service, each of the at least one HE service being a service the network user is authorized to receive by a home network service provider.

3. The method of claim 1, wherein the communicating step communicates at least one value-added service supported by a service platform of a network currently serving the network user, each of the at least one value-added service being a service the network user is not authorized to receive by a home network service provider.

4. The method of claim 1, wherein the communicating step communicates at least one value-added service supported by a third party service platform, each of the at least one value-added service being a service the network user is not authorized to receive by a home network service provider.

5. The method of claim 1, wherein the communicating step communicates at least one application service, each of the at least one application service being a service that supports at least one of functionality and content available to the network user.

6. The method of claim 1, wherein the communicating step communicates at least one bearer service, each of the at least one bearer service being a service that supports at least one of connectivity and data transmission for the network user.

7. The method of claim 6, wherein the communicating step communicates at least one of a group of bearer services consisting of public switched telephone networks (PSTN), integrated services digital networks (ISDN), packet-switched data networks, and Internet protocol (IP) networks.

8. The method of claim 1, further comprising:
initiating the communicating step at a third party service platform.

9. The method of claim 1, further comprising:
initiating the communicating step at a network serving user terminal equipment of the network user.

10. The method of claim 9, wherein initiating step initiates the communicating step in response to receiving a message, the received message being one of a registration request from the user terminal equipment and a service discovery request from a visited network into which the user terminal equipment has roamed.

11. The method of claim 10, further comprising:
collecting the list of available network services based on the user-specific information, wherein the collecting step includes, obtaining the user-specific information based on the received message; and
interrogating at least a database to determine services available to the network user based on the obtained user-specific information.

12. The method of claim 11, wherein the obtaining step obtains at least one of user identification, user terminal equipment location, user terminal equipment capabilities, and user preferences.

13. The method of claim 12, wherein the interrogating step includes determining one or more home environment (HE) services available to the user by querying the database according to the user identification, the database being located at a home network service provider to which the network user subscribes, each of the HE services being a service the network user is authorized to receive by a home network service provider.

14. The method of claim 13, wherein the collecting step collects the determined available HE services identified in a roaming agreement between the visited network and a home network service provider to which the user subscribes when the visited network is the serving network.

15. The method of claim 13, the serving network being the visited network, wherein the collecting step further includes collecting the determined available HE services supported by the visited network when the visited network is the serving network.

16. The method of claim 13, wherein the interrogating step further includes determining one or more value-added services available to the network user by performing a database query according to at least one of the user terminal equipment capabilities and the user terminal equipment location, each of the value-added services being a service the network user is not authorized to receive by a home network service provider.

17. The method of claim 16, wherein the step of determining value-added services includes determining one or more third party service platforms based on the user terminal equipment location.

18. The method of claim 17, wherein the collecting step further includes querying the determined third party service platforms to collect third party value-added services supported by the user terminal equipment capabilities.

19. The method of claim 12, wherein
the interrogating step includes determining at least one third party service platform corresponding to the user terminal equipment location, and
the collecting step collects one or more value-added service provided by the determined at least one third party service platform, each of the value-added services being a service the network user does not receive based on a subscription to a home network service provider.

20. The method of claim 12, wherein the obtaining step includes performing a lookup of a user profile database based on the user identification to obtain at least one of the user preferences and the user terminal equipment capabilities

21. The method of claim 12, wherein the obtaining step includes performing a lookup of a location register database to obtain the user terminal equipment location.

22. The method of claim 9, further comprising:
receiving a service registration request from the user terminal equipment in response to the communicated list of available network services, the service registration request identifying a network service from the list of available network services; and
registering the user terminal equipment for the identified network service.

23. A method for determining available network services, comprising:
receiving a list of one or more available network services based on user-specific information.

24. The method of claim 23, wherein the receiving step receives at least one home environment (HE) service, each of the at least one HE service being a service that a network user associated with the user-specific data is authorized to receive by a home network service provider.

25. The method of claim 23, wherein the receiving step receives at least one value-added service supported by a service platform of a network currently serving a network user associated with the user-specific data, each of the at least one value-added service being a service the network user is not authorized to receive by a home network service provider.

26. The method of claim 23, further comprising:
sending a message over a network, the message including the user-specific data,
wherein the receiving step receives a list of available network services, which is communicated over the network in response to the sent message.

27. The method of claim 26, wherein the sending step sends at least one of a registration request and a service discovery request.

28. The method of claim 26, wherein the sending step sends a message including at least one of user identification, user terminal equipment location, user terminal equipment capabilities, and user preferences.

29. The method of claim 23, the receiving step being performed by user terminal equipment, wherein the receiving step receives the list of available network services from a network serving the network user terminal equipment.

30. The method of claim 23, the receiving step being performed by user terminal equipment, wherein the receiving step receives the list of available network services from a visited network into which the user terminal equipment has roamed.

31. The method of claim 23, the receiving step being performed by user terminal equipment, further comprising:
sending a service registration request identifying a network service from the list of available services in order to register the user terminal equipment for the identified network service.
